(19) United States
(12) Patent Application Publication
(10) Pub. No.: US 2006/0047411 A1
(43) Pub. Date: Mar. 2, 2006

(54) Method and apparatus for unattended data collection

(76) Inventors: Timothy A. Robinson, Avon, IN (US); James H. Stewart, Gulfport, MS (US); Stephen J. Hussey, Pittsboro, IN (US); Yared G. Tadesse, Indianapolis, IN (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 11/172,499

(22) Filed: Jun. 30, 2005

Related U.S. Application Data
(60) Provisional application No. 60/604,764, filed on Aug. 26, 2004.
(60) Provisional application No. 60/604,773, filed on Aug. 26, 2004.

(51) Int. Cl. G06F 17/00

(52) U.S. Cl. 701/117; 701/2

(57) ABSTRACT

A method for unattended data collection is provided. The method monitors, stores and/or transmits data representative of the operation of a component or system, whereby the transmitted data may be analyzed and vehicle performance improved through the analysis thereof.

### CROSS REFERENCE TO RELATED APPLICATIONS

This Application claims the benefit of U.S. Provisional Applications 60/604,764 and 60/604,773, filed Aug. 26, 2004, which are each hereby incorporated by reference in their entirety.

### BACKGROUND OF THE INVENTION

Onboard vehicle maintenance systems, diagnostic systems, engineering development devices, and testing systems that monitor vehicular components and systems typically rely on manual input from an operator and/or technician and require the physical presence of the vehicle during analysis.

### SUMMARY OF THE INVENTION

An automated data collection and transmission system would provide the ability to observe the behavior of vehicular components and systems in the field (i.e. remotely), as the components and systems are being operated, which would provide significant advantages to vehicle manufacturers. A method and apparatus for unattended (i.e. remote) data collection is therefore provided. The apparatus includes a maintenance system for a vehicle having a component or system with a measurable characteristic. The maintenance system includes at least one sensor configured and positioned with respect to the component or system to measure, and thereby obtain a value for, the measurable characteristic.

The sensor transmits a signal indicating the value of the measurable characteristic to a microprocessor. The microprocessor is configured according to the method of the present invention to analyze the value of the measurable characteristic and thereby identify correctable aberrations in the vehicle's operation. The microprocessor is further configured to transmit the value of the measurable characteristic which may be indicative of a potential aberration to a user interface.

Preferably, the maintenance system includes a data recorder module for transmitting values of the measurable characteristic to an offboard network or data collection device, and for receiving instructions therefrom to correct aberrations in the vehicle's operation. The maintenance system is thus able to regularly communicate performance data of the component or system to an offboard network for use by a technician or others.

The ability to transmit data from a vehicle to a remote location is particularly advantageous, for example, when a vehicle is inaccessible. Vehicles are often tested in distant, environmentally extreme locations and the ability to collect vehicle data from vehicles in such locations without physically visiting the vehicles would simplify the process of vehicle testing. Further, a system that allows an engineer to collect data from a vehicle as it is being operated by a consumer would allow for the engineer to access vehicle system data without taking control of the vehicle away from the consumer.

An automated or unattended data collection and transmission system is also preferably provided according to a method of the present invention. Such a system removes the obligation of manually controlling data collection while retaining the advantages inherent in manual data collection. Such a system may provide valuable advantages over strictly manual data collection systems. An automated data collection system may eliminate user error, thereby improving the quality of the data. Further, an automated data collection system potentially provides for detection of vehicle malperformance prior to its detection by the operator. Automated vehicle system data collection may also improve vehicle performance in a vast multitude of driving conditions by continuously monitoring the vehicle and adjusting its systems to function at peak performance depending upon the vehicle's physical location and current driving environment.

The apparatus of the present invention is preferably composed of hardware adapted to initialize quickly after power-up, thereby allowing data collection much sooner after vehicle ignition than previously possible. Similarly, the method of the present invention is preferably composed of an algorithm optimized for quick initialization after power-up. Additionally, the apparatus is preferably configured to automatically shut down after the vehicle's ignition is turned off such that the vehicle battery is not drained.

The above features, and advantages, and other features, and advantages, of the present invention are readily apparent from the following detailed description of the best modes for carrying out the invention when taken in connection with the accompanying drawings.

### BRIEF DESCRIPTION OF THE DRAWINGS

FIG. 1 is a block diagram illustrating a method according to a preferred embodiment of the present invention;

FIG. 2 is a block diagram illustrating a step of the method of FIG. 1;

FIG. 3 is a block diagram illustrating a step of the method of FIG. 1;

FIG. 4 is a block diagram illustrating a step of the method of FIG. 3;

FIG. 5 is a block diagram illustrating a step of the method of FIG. 3;

FIG. 6 is a block diagram illustrating a step of the method of FIG. 5; and

FIG. 7 is a block diagram illustrating a step of the method of FIG. 6.

### DESCRIPTION OF THE PREFERRED EMBODIMENTS

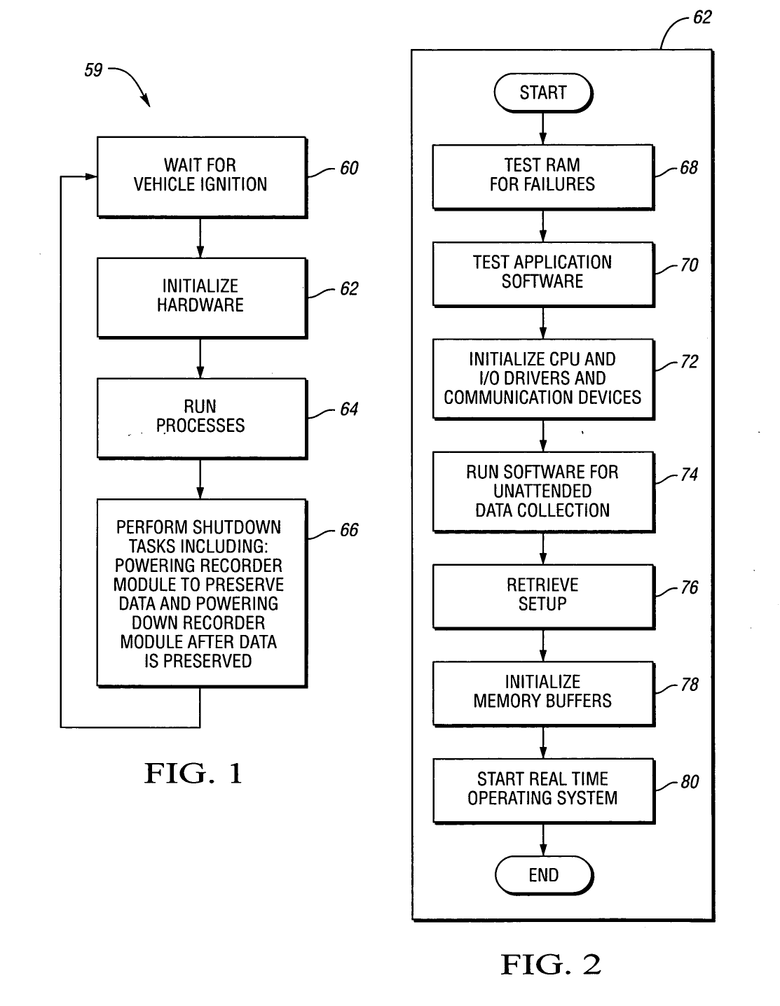

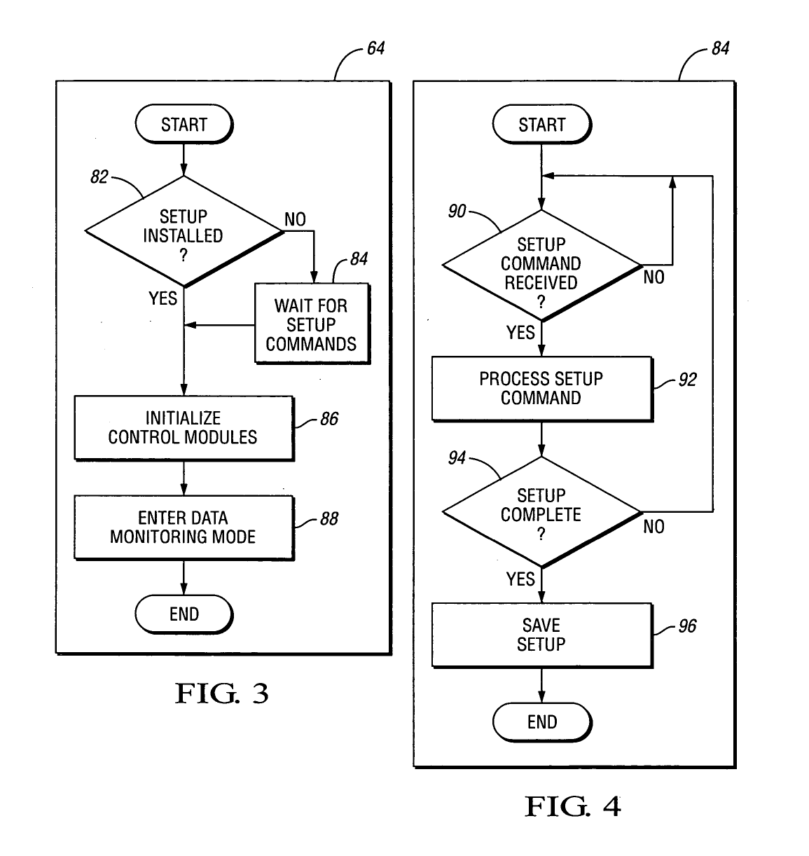

FIGS. 1-7 depict a method of the present invention. More precisely, FIGS. 1-7 show a series of block diagrams representing steps performed by the microprocessor 40 (shown in FIG. 3 of incorporated application No. 60/604,773).

Referring to FIG. 1, the method of unattended data collection 59 (also referred to herein as algorithm 59) of the present invention is configured at step 60 to initiate the algorithm when the vehicle 10 (shown in FIG. 1 of incorporated application No. 60/604,773) is started as indicated by the receipt of a vehicle ignition signal. At step 62, the data recorder module 26 (shown in FIGS. 2-3 of incorporated application No. 60/604,773) is initialized. At step 64, the algorithm runs the data recorder module process as will be described in detail hereinafter. At step 66, shutdown tasks are performed.

The shutdown tasks of step 66 are preferably user-defined but may include, for example, saving vehicle setup data as will be described in detail hereinafter. Also at step 66, when vehicle shutdown is detected the power supply circuit 50 (shown in FIG. 3 of incorporated application No. 60/604,773) powers the data recorder module 26 (shown in FIGS. 2-3 of incorporated application No. 60/604,773) long enough to allow the microprocessor 40 (shown in FIG. 3 of incorporated application No. 60/604,773) to save any relevant data. After the relevant data has been saved, the data recorder module 26 is powered-down by the power supply circuit 50. In this manner, the vehicle's battery (not shown) is not unnecessarily drained because the data recorder module 26 is powered by the power supply circuit 50 when the vehicle 10 (shown in FIG. 1 of incorporated application No. 60/604,773) is not running. Additionally, energy is conserved by automatically powering-down the data recorder module 26 after the relevant data has been saved.

Referring to FIG. 2, step 62, wherein the data recorder module is initialized, is shown in more detail. At step 68 the storage device 42 (referred to as RAM and shown in FIG. 3 of incorporated application No. 60/604,773) is tested. At step 70, the data recorder module application software is tested. At step 72, the microprocessor 40 (referred to as CPU and shown in FIG. 3 of incorporated application No. 60/604,773), the drivers for the input/output interface 46 (shown in FIG. 3 of incorporated application No. 60/604,773), and all other communication devices such as global positioning system (GPS) connections, cellular phone connections, etc. are initialized. At step 74, data recorder module software for unattended data collection is run. Steps 76-80 represent steps performed by the software for unattended data collection run in step 74. Accordingly, at step 76 vehicle setup data is retrieved, at step 78 data recorder module memory buffers are initialized, and at step 80 the real time operating system is started.

The vehicle setup data retrieved at step 76 includes data specific to a particular vehicle and may include, for example, data pertaining to the vehicle type, weight, engine displacement, transmission configuration, etc. The setup data is preferably saved prior to vehicle shutdown and retrieved from its stored location at step 76. The data recorder module memory buffer initialization at step 78 preferably includes a RAM buffer wherein data is written until the memory is full, and thereafter the earliest recorded data is written over. At step 78 removable flash memory 44 (shown in FIG. 3 of incorporated application No. 60/604,773) is also preferably indexed to determine memory status, number of data files saved, and remaining memory available.

Referring to FIG. 3, step 64, wherein the data recorder module processes are run, is shown in more detail. At step 82, the algorithm 59 checks to see if the vehicle setup data is installed. If the vehicle setup data is not installed, the algorithm 59 waits for setup commands at step 84 as will be described in detail hereinafter. If the vehicle setup data is installed, one or more control modules (not shown) are initialized at step 86. Thereafter, at step 88, the algorithm 59 enters a data monitoring mode as will be described in detail hereinafter.

The setup commands of step 84 generally indicate which type of vehicle setup data to collect. The setup commands of step 84 would typically be received from an external source such as an offsite computer. The control modules initialized at step 86 may include any of the vehicle's control modules such as, for example, a module configured to control any of the vehicles plurality of components and systems identified hereinabove. The vehicle setup data of step 82 is preferably implemented to tell the various control modules which type of data to broadcast.

Referring to FIG. 4, step 84, wherein the algorithm 59 waits for setup commands, is shown in more detail. At step 90, the data recorder module checks for setup commands. If the setup commands have not been received, step 90 is repeated until such commands are available. After receiving the setup commands, these commands are processed at step 92. At step 94, the algorithm 59 determines whether setup is complete. If setup is not complete, the algorithm 59 returns to step 90. If setup is complete, the setup parameters are saved at step 96.

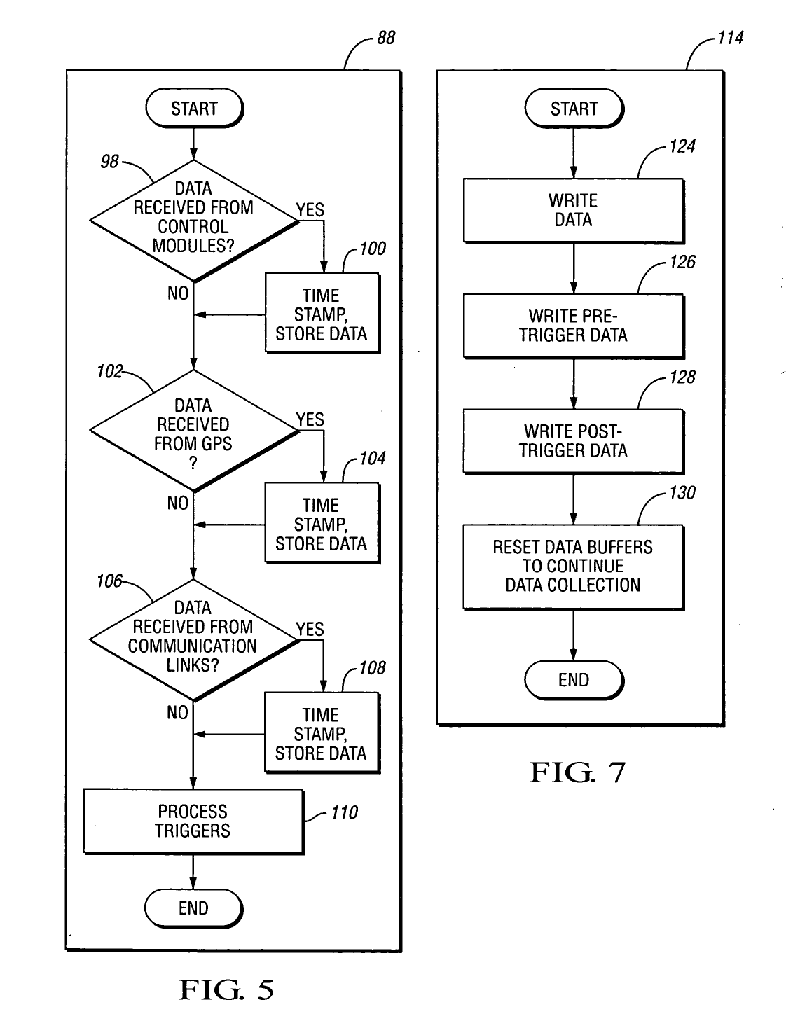

Referring to FIG. 5, step 88, wherein the algorithm 59 enters a data monitoring mode, is shown in more detail. At step 98, the algorithm 59 checks to see if control module data has been received from any of the vehicle control modules (not shown). If such data has been received, the control module data is time stamped and stored at step 100, and thereafter the algorithm 59 proceeds to step 102. If there is no control module data, the algorithm 59 proceeds directly to step 102. At step 102, the algorithm 59 checks to see if GPS data has been received. If such data has been received, the GPS data is time stamped and stored at step 104, and thereafter the algorithm 59 proceeds to step 106. If there is no GPS data, the algorithm 59 proceeds directly to step 106. At step 106, the algorithm 59 checks to see if data has been received from the communication links (not shown). Communication link data pertains to data transferred back and forth between vehicle control modules (not shown). If such data has been received, the communication link data is time stamped and stored at step 108, and thereafter the algorithm 59 proceeds to step 110. If there is no communication link data, the algorithm 59 proceeds directly to step 110. At step 110 triggers are processed as will be discussed in detail hereinafter.

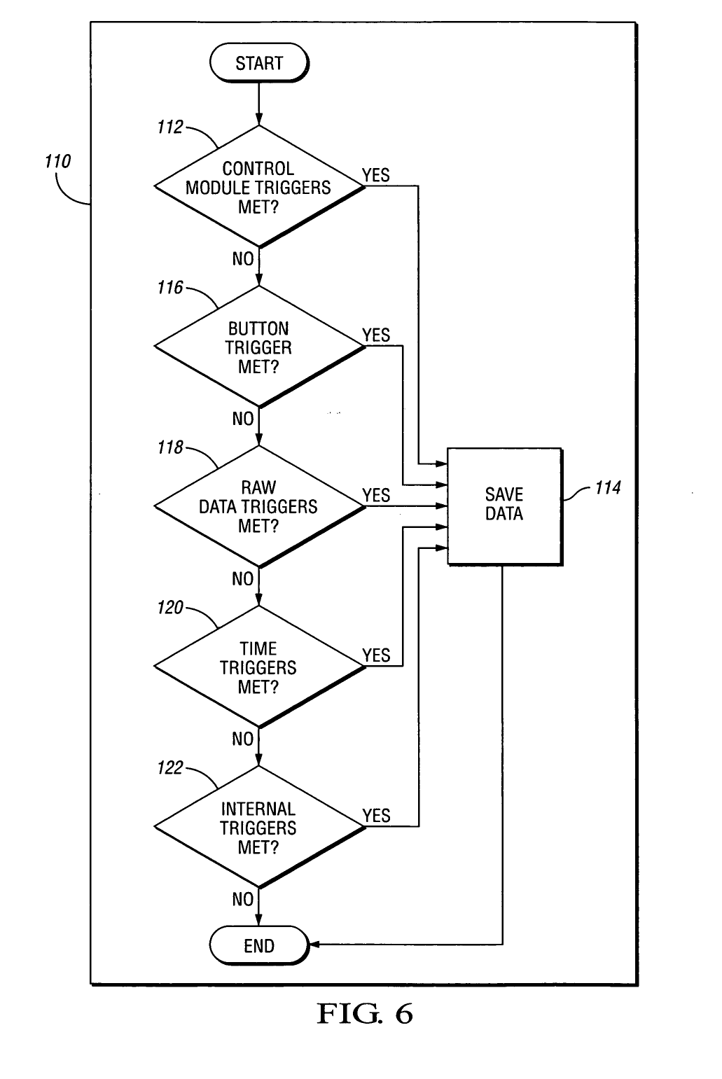

Referring to FIG. 6, the trigger processing step 110 is shown in more detail. A trigger typically refers to any data outside of a predetermined range or threshold that, because it is outside of the predetermined range, triggers the data recorder. A trigger may, however, simply refer to a signal such as that generated by the manual transmit button 23 (shown in FIG. 2 of incorporated application No. 60/604,773) and described in detail hereinafter.

At step 112, the algorithm 59 checks to see if the control module triggers have been met. If the control module triggers have been met, relevant vehicle data is saved at step 114. If the control module triggers have not been met, the algorithm 59 proceeds directly to step 116. Control module triggers are typically user defined and may include, for example, a maximum engine temperature, engine rpm value or maximum shift time.

At step 116, the algorithm 59 checks to see if the trigger for the manual transmit button 23 (shown in FIG. 2 of incorporated application No. 60/604,773) has been met (i.e., if the manual transmit button has been pushed). The manual transmit button 23 is preferably disposed within the vehicle's passenger compartment and is electronically connected to the ECU 24 (shown in FIG. 2 of incorporated application No. 60/604,773). The manual transmit button 23 generates a transmit signal 25 telling the ECU 24 to transmit the recorded data, and thereby allows an occupant of the vehicle to manually transmit data if, for example, the vehicle is operating abnormally. If the manual transmit button trigger has been met, relevant vehicle data is saved at step 114. If the manual transmit button trigger has not been met, the algorithm 59 proceeds directly to step 118.

At step 118, the algorithm 59 checks to see if the raw data triggers have been met. If the raw data triggers have been met, relevant vehicle data is saved at step 114. If the raw data triggers have not been met, the algorithm 59 proceeds directly to step 120. The raw data triggers pertain to data transferred between control modules. In all other respects the type of trigger described in step 118 is similar to that of step 112 described hereinabove.

At step 120, the algorithm 59 checks to see if the time threshold triggers have been met. If the time threshold triggers have been met, relevant vehicle data is saved at step 114. If the time threshold triggers have not been met, the algorithm 59 proceeds directly to step 122. Time threshold triggers are predetermined periodic triggers such as, for example, a trigger configured to store data every five minutes.

At step 122, the algorithm 59 checks to see if any internal data triggers have been met. If the internal data triggers have been met, relevant vehicle data is saved at step 114. If the internal data triggers have not been met, the algorithm 59 proceeds to the end of step 110. Internal data triggers include, for example, a signal from a remote cell phone or offsite computer.

Referring to FIG. 7, the vehicle data saving step 114 is shown in more detail. At step 124, relevant vehicle data is written, preferably to the storage device 42 (shown in FIG. 3 of incorporated application No. 60/604,773), however it should be appreciated that such data may be written to any number of alternate storage devices. The type of data considered relevant is user-defined and may include, for example, the triggering event, the time and date saved, the amount of data stored, etc. At step 126, pre-trigger data is written. At step 128, post-trigger data is written. Pre-trigger and post-trigger data may be useful for an analysis of vehicle operation leading up to a triggering event, and to ensure proper vehicle operation after the triggering event. At step 130, the data recorder module data buffers are reset to enable continuation of data collection.

The steps shown in FIGS. 1-7 and described herein need not be performed in the order shown.

As set forth in the claims, various features shown and described in accordance with the different embodiments of the invention illustrated may be combined.

While the best modes for carrying out the invention have been described in detail, those familiar with the art to which this invention relates will recognize various alternative designs and embodiments for practicing the scope of the invention within the scope of the appended claims

1. A method for collecting data from a vehicle comprising:
initializing a recorder module;
receiving a setup command remotely from the vehicle wherein the setup command indicates the type of data to be collected;
collecting data from one or more predefined sources in response to the setup command;
determining if one or more predefined triggers are met;
recording at least a portion of the data in the recorder module if one of the predefined triggers has been met; and
powering-down the recorder module after the vehicle has been turned off to conserve energy.

2. The method of claim 1, wherein said collecting data includes collecting data from one or more vehicle control modules.

3. The method of claim 1, wherein said collecting data includes collecting data from a global positioning system.

4. The method of claim 1, wherein said collecting data includes collecting data from a vehicles internal communication links.

5. The method of claim 1, wherein said determining if one or more predefined triggers are met includes determining if a control module trigger has been met.

6. The method of claim 1, wherein said determining if one or more predefined triggers are met includes determining if a manual transmit button trigger has been met.

7. The method of claim 1, wherein said determining if one or more predefined triggers are met includes determining if a raw data trigger has been met.

8. The method of claim 1, wherein said determining if one or more predefined triggers are met includes determining if a time trigger has been met.

9. The method of claim 1, wherein said determining if one or more predefined triggers are met includes determining if an internal trigger has been met.

10. The method of claim 1 further comprising supplying power to the recorder module after the vehicle is turned off such that any unrecorded data may be preserved.

11. A method for collecting data from a vehicle comprising:
initializing a recorder module;
receiving a setup command remotely from the vehicle wherein the setup command indicates the type of data to be collected;
collecting data from one or more predefined sources in response to the setup command;
determining if one or more predefined triggers are met;
recording at least a portion of the data in the recorder module if one of the predefined triggers has been met;
supplying power to the recorder module after the vehicle is turned off such that any unrecorded data may be preserved; and
powering-down the recorder module after the unrecorded data is preserved to conserve energy.

12. The method of claim 11, wherein said determining if one or more predefined triggers are met includes determining if a control module trigger has been met.

13. The method of claim 11, wherein said determining if one or more predefined triggers are met includes determining if a manual transmit button trigger has been met.

14. The method of claim 11, wherein said determining if one or more predefined triggers are met includes determining if a raw data trigger has been met.

15. The method of claim 11, wherein said determining if one or more predefined triggers are met includes determining if a time trigger has been met.

16. The method of claim 11, wherein said determining if one or more predefined triggers are met includes determining if an internal trigger has been met.

17. A method for collecting data from a vehicle comprising:
initializing a recorder module;
receiving a setup command remotely from the vehicle indicating the type of data to be collected;
collecting data from one or more predefined sources in response to the setup command;
determining if one or more predefined triggers are met;
recording at least a portion of the data in the recorder module if one of the predefined triggers has been met; and
supplying power to the recorder module after the vehicle is turned off such that any unrecorded data may be preserved.

18. The method of claim 17, wherein said determining if one or more predefined triggers are met includes determining if a control module trigger has been met.

19. The method of claim 17, wherein said determining if one or more predefined triggers are met includes determining if a manual transmit button trigger has been met.

20. The method of claim 17, wherein said determining if one or more predefined triggers are met includes determining if a raw data trigger has been met.
